(19) United States
(12) Patent Application Publication
(10) Pub. No.: US 2021/0398513 A1
(43) Pub. Date: Dec. 23, 2021

(54) Rechargeable Battery Powered Stringed Instrument Assembly

(71) Applicant: Barry Franklin, San Diego, CA (US)

(72) Inventor: Barry Franklin, San Diego, CA (US)

(21) Appl. No.: 16/908,109

(22) Filed: Jun. 22, 2020

(51) Int. Cl. G10H 3/18; H02J 7/02

(52) U.S. Cl. CPC G10H 3/181; G10H 2240/285; G10H 2230/035; H02J 7/02

(57) ABSTRACT

A rechargeable battery powered stringed instrument assembly for eliminating a requirement to replace batteries includes a stringed instrument, which comprises an active pickup and which has a battery and a connector engaged thereto. The connector is operationally engaged to the battery, which is rechargeable. A power cord is selectively engageable to the connector and is configured to selectively engage an electrical circuit to operationally engage the battery to the electrical circuit. The power cord allows flow of electrical current from the electrical circuit to the battery to charge the battery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stringed instrument assemblies and more particularly pertains to a new stringed instrument assembly for eliminating a requirement to replace batteries.

### (2) Description of Related Art Including Information Disclosed Under 37 CFR 1.97 and 1.98

The prior art relates to stringed instrument assemblies. Prior art stringed instrument assemblies may comprise contactless charging systems, batteries integral to signal plugs of signal cables, charging modules, and power storage modules.

### BRIEF SUMMARY OF THE INVENTION

An embodiment of the disclosure meets the needs presented above by generally comprising a stringed instrument, which comprises an active pickup and which has a battery and a connector engaged thereto. The connector is operationally engaged to the battery, which is rechargeable. A power cord is selectively engageable to the connector and is configured to selectively engage an electrical circuit to operationally engage the battery to the electrical circuit. The power cord is configured to allow flow of electrical current from the electrical circuit to the battery to charge the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a rechargeable battery powered stringed instrument assembly according to an embodiment of the disclosure.

FIG. 2 is a front view of an embodiment of the disclosure.

FIG. 3 is a side view of an embodiment of the disclosure.

FIG. 4 is a block diagram of an embodiment of the disclosure.

### DETAILED DESCRIPTION OF THE INVENTION

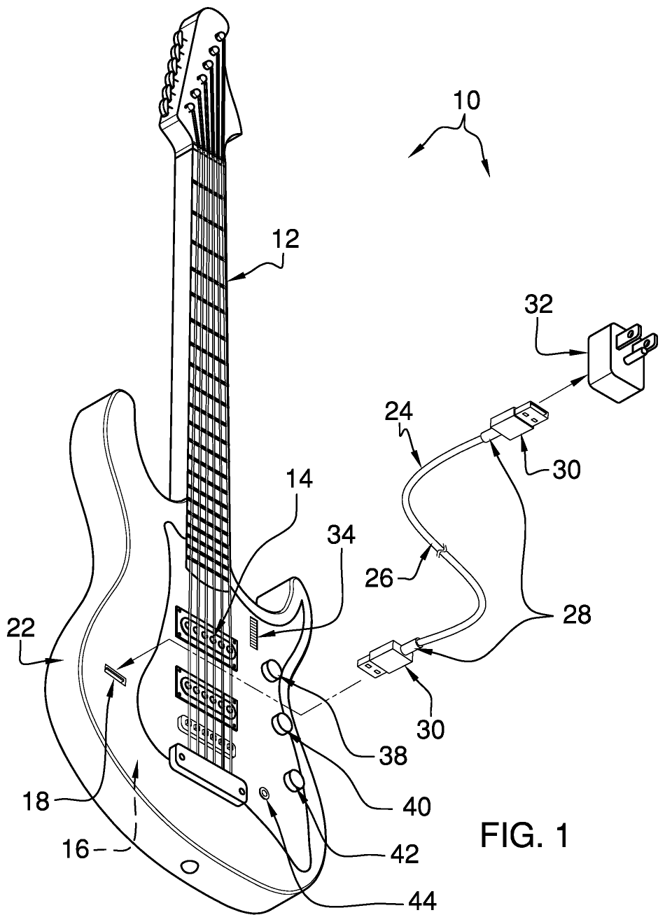

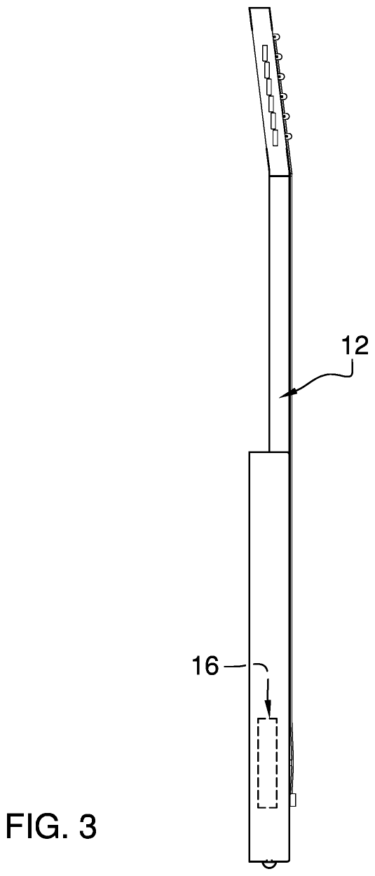

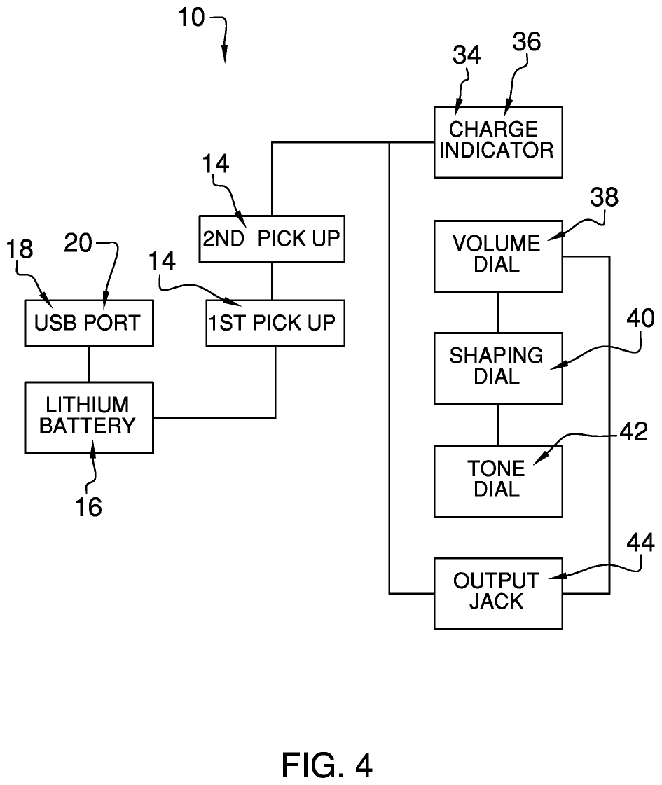

With reference now to the drawings, and in particular to FIGS. 1 through 4 thereof, a new stringed instrument embodying the principles and concepts of an embodiment of the disclosure and generally designated by the reference numeral 10 will be described.

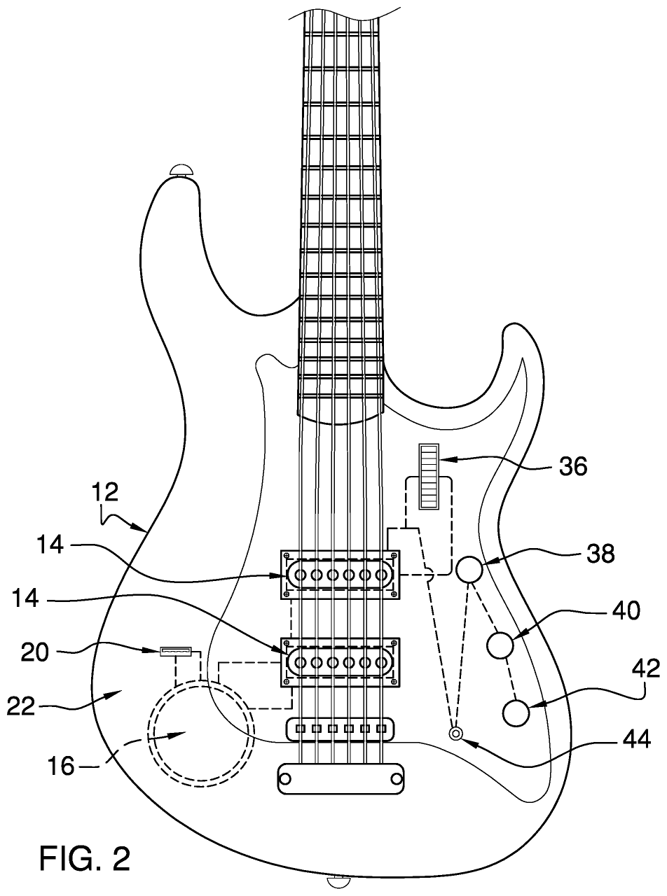

As best illustrated in FIGS. 1 through 4, the rechargeable battery powered stringed instrument assembly 10 generally comprises a stringed instrument 12, which comprises an active pickup 14 and which has a battery 16 and a connector 18 engaged thereto. The stringed instrument 12 comprises at least one of a guitar, a bass guitar, an upright bass, and an acoustic guitar. The present invention also anticipates the stringed instrument 12 comprising other types of instruments, such as, but not limited to, violins, violas, sitars, ukuleles, and the like. The active pickup 14 may be one of a pair of active pickups 14, as shown in FIG. 2.

The connector 18 is operationally engaged to the battery 16, which is rechargeable. The connector 18 may comprise a Universal Serial Bus port 20, as shown in FIG. 2, or other connecting means, such as, but not limited to, sockets for barrel plugs, snap and lock connectors, and the like. The battery 16 may comprise lithium, or other elements known to those skilled in the art of rechargeable batteries, such as, but not limited to, zinc, sodium, silver, and the like. The battery 16 may be positioned within a body 22 of the stringed instrument 12 or may be attached thereto. The battery 16 is configured to supply up to 1200 milliamperes.

A power cord 24 is selectively engageable to the connector 18 and is configured to selectively engage an electrical circuit to operationally engage the battery 16 to the electrical circuit. The power cord 24 is configured to allow flow of electrical current from the electrical circuit to the battery 16 to charge the battery 16. The power cord 24 may comprise a cable 26, which has opposed ends 28. Each opposed end 28 has a Universal Serial Bus plug 30 engaged thereto.

The assembly 10 also may comprise an adapter 32, which is selectively engageable to the power cord 24. The adapter 32 is configured to selectively engage a source of alternating current and to convert alternating current to direct current. The present invention also anticipates the power cord 24 and the adapter 32 being fixedly engaged.

The assembly 10 also comprises a display 34, which is engaged to the stringed instrument 12 and which is operationally engaged to the battery 16. The display 34 is configured to indicate a charge level of the battery 16. The display 34 may comprise a bar graph 36, which is configured to selectively emit light of a variety of colors. Each color indicates an associated charge level of the battery 16. The present invention anticipates the display 34 comprising other indicating means, such as, but not limited to, indicating dials, bulbs emitting light of various colors, and the like.

The stringed instrument 12 may comprise a volume controller 38, a shaping controller 40, a tone controller 42, and an output jack 44, which are operationally engaged to the active pickup 14. The volume controller 38 is configured to control a volume of a signal sent by the active pickup 14. The shaping controller 40 is configured to shape the signal sent by the active pickup 14. The tone controller 42 is configured to adjust a tone of the signal sent by the active pickup 14. The output jack 44 is configured to selectively engage the stringed instrument 12 to an amplification device (not shown) and to relay the signal thereto.

In use, the assembly 10 is utilized as per prior art instruments having replaceable batteries. When recharging of the battery 16 is required, the power cord 24 is engaged to the connector 18 and the adapter 32. The adapter 32 then is plugged into an outlet to charge the battery 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A rechargeable battery powered stringed instrument assembly comprising:
a stringed instrument comprising an active pickup;
a battery engaged to the stringed instrument, the battery being rechargeable;
a connector engaged to the stringed instrument and being operationally engaged to the battery; and
a power cord selectively engageable to the connector and being configured for selectively engaging an electrical circuit for operationally engaging the battery to the electrical circuit, wherein the power cord is configured for flow of electrical current from the electrical circuit to the battery for charging the battery.

2. The rechargeable battery powered stringed instrument assembly of claim 1, wherein the stringed instrument comprises at least one of a guitar, a bass guitar, an upright bass, and an acoustic guitar.

3. The rechargeable battery powered stringed instrument assembly of claim 1, wherein the active pickup is one of a pair of active pickups.

4. The rechargeable battery powered stringed instrument assembly of claim 1, wherein the battery comprises lithium.

5. The rechargeable battery powered stringed instrument assembly of claim 1, wherein the battery is positioned within a body of the stringed instrument.

6. The rechargeable battery powered stringed instrument assembly of claim 1, wherein the battery is configured for supplying up to 1200 milliamperes.

7. The rechargeable battery powered stringed instrument assembly of claim 1, further including an adapter selectively engageable to the power cord, the adapter being configured for selectively engaging a source of alternating current and for converting alternating current to direct current.

8. The rechargeable battery powered stringed instrument assembly of claim 1, wherein:
the connector comprises a Universal Serial Bus port; and
the power cord comprises a cable having opposed ends, each opposed end having a Universal Serial Bus plug engaged thereto.

9. The rechargeable battery powered stringed instrument assembly of claim 8, further including an adapter selectively engageable to the power cord, the adapter being configured for selectively engaging a source of alternating current and for converting alternating current to direct current.

10. The rechargeable battery powered stringed instrument assembly of claim 1, further including an display engaged to the stringed instrument and being operationally engaged to the battery, wherein the display is configured for indicating a charge level of the battery.

11. The rechargeable battery powered stringed instrument assembly of claim 10, wherein the display comprises a bar graph.

12. The rechargeable battery powered stringed instrument assembly of claim 1, wherein the stringed instrument comprises:
a volume controller operationally engaged to the active pickup and being configured for controlling a volume of a signal sent by the active pickup;
a shaping controller operationally engaged to the active pickup and being configured for shaping the signal sent by the active pickup;
a tone controller operationally engaged to the active pickup and being configured for adjusting a tone of the signal sent by the active pickup; and
an output jack operationally engaged to the active pickup and being configured for selectively engaging the stringed instrument to an amplification device and for relaying the signal thereto.

13. A rechargeable battery powered stringed instrument assembly comprising:
a stringed instrument comprising an active pickup, the stringed instrument comprising at least one of a guitar, a bass guitar, an upright bass, and an acoustic guitar, the active pickup being one of a pair of active pickups;
a battery engaged to the stringed instrument, the battery being rechargeable, the battery comprising lithium, the battery being positioned within a body of the stringed instrument, the battery being configured for supplying up to 1200 milliamperes;
a connector engaged to the stringed instrument and being operationally engaged to the battery, the connector comprising a Universal Serial Bus port;
a power cord selectively engageable to the connector and being configured for selectively engaging an electrical circuit for operationally engaging the battery to the electrical circuit, wherein the power cord is configured for flow of electrical current from the electrical circuit to the battery for charging the battery, the power cord comprising a cable having opposed ends, each opposed end having a Universal Serial Bus plug engaged thereto;
an adapter selectively engageable to the power cord, the adapter being configured for selectively engaging a source of alternating current and for converting alternating current to direct current;
an display engaged to the stringed instrument and being operationally engaged to the battery, wherein the display is configured for indicating a charge level of the battery, the display comprising a bar graph; and
the stringed instrument comprising:
a volume controller operationally engaged to the active pickup and being configured for controlling a volume of a signal sent by the active pickup,
a shaping controller operationally engaged to the active pickup and being configured for shaping the signal sent by the active pickup,
a tone controller operationally engaged to the active pickup and being configured for adjusting a tone of the signal sent by the active pickup, and
an output jack operationally engaged to the active pickup and being configured for selectively engaging the stringed instrument to an amplification device and for relaying the signal thereto.
